(19) United States
(12) Patent Application Publication
(10) Pub. No.: US 2018/0126290 A1
(43) Pub. Date: May 10, 2018

(54) ADJUSTABLE VEHICLE CHASSIS FOR A RC VEHICLE

(71) Applicant: HORIZON HOBBY, LLC, Champaign, IL (US)

(72) Inventors: Todd Hodge, Champaign, IL (US); Franklin Root, Champaign, IL (US); Mike Mellin, Champaign, IL (US)

(21) Appl. No.: 15/803,477

(22) Filed: Nov. 3, 2017

Related U.S. Application Data
(60) Provisional application No. 62/418,255, filed on Nov. 6, 2016.

(51) Int. Cl. A63H 17/26

(52) U.S. Cl. CPC A63H 17/262; B60G 7/003

(57) ABSTRACT

Remote control vehicles may benefit from a chassis that is easy to adjust. For example, an adjustable chassis may contain a front suspension arm that quickly and easily allows shock position changes without requiring disassembly of the shock and while maintaining the same suspension travel. The adjustable chassis may contain a rear camber block with camber inserts that quickly and easily allow changes in roll center without having to remove ball studs. The adjustable chassis may also include a rear shock tower that sweeps forward to allow mounting of the wing closer to the front of the vehicle, thus improving vehicle aerodynamics.

### CROSS REFERENCE TO RELATED APPLICATIONS

This application claims priority under 35. U.S.C. § 119 to U.S. Provisional Application Ser. No. 62/418,255 filed Nov. 6, 2016, the contents of which are incorporated by reference herein in its entirety.

The present disclosure relates to systems and methods for a radio-controlled (RC) vehicle, such as a car, truck, buggy, or other surface vehicle. More specifically, disclosed embodiments relate to an adjustable chassis for a RC vehicle.

### BACKGROUND

RC vehicles have been in operation for many years. In basic form, RC vehicles are self-powered model vehicles (e.g., cars, trucks, buggies, boats, or other surface vehicles) that can be controlled from a distance using a specialized transmitter (or controller). For example, a transmitter may be used to control the speed, direction, and orientation of an RC vehicle.

RC drivers may race RC vehicles competitively and desire the ability to adjust characteristics of the RC vehicle (e.g., so the vehicle works better on a particular terrain). Thus, a need exists to efficiently adjust characteristics of a RC vehicle.

### SUMMARY

In some embodiments, a RC vehicle includes a chassis. The RC vehicle includes a front suspension arm coupled to the chassis with a plurality of suspension arm shock apertures. The RC vehicle includes a rear camber block coupled to the chassis and configured to accept a plurality of camber inserts. The RC vehicle includes a rear shock tower coupled to the chassis, wherein the rear shock tower sweeps forward such that a wing is mounted in a forward position.

### BRIEF DESCRIPTION OF THE DRAWINGS

FIG. 1 illustrates a top view of an adjustable chassis of a radio-controlled (RC) vehicle, according to an example embodiment.

FIG. 2A is a perspective view of a suspension arm of a RC vehicle, according to an example embodiment.

FIG. 2B is a top view of the suspension arm of FIG. 2A.

FIG. 2C is a side view of the suspension arm of FIG. 2A.

FIG. 3 is a cut-out view of a RC vehicle, further illustrating a suspension arm, according to an example embodiment.

FIG. 4A is a cut-out view of a RC vehicle, further illustrating a camber block according to an example embodiment.

FIG. 4B is an exploded view of the camber block of FIG. 4A.

FIG. 5A illustrates an example camber insert, according to an example embodiment.

FIG. 5B illustrates an example camber insert, according to an example embodiment.

FIG. 5C illustrates an example camber insert, according to an example embodiment.

FIG. 6A is a perspective view of a shock tower, according to an example embodiment.

FIG. 6B is a side view of the shock tower of FIG. 6A.

FIG. 6C is a front view of the shock tower of FIG. 6A.

FIG. 7A is a cut-out and side view of a RC vehicle, further illustrating the shock tower of FIG. 6A.

FIG. 7B is a top view of FIG. 7A.

### DETAILED DESCRIPTION

The following detailed description includes references to the accompanying figures. In the figures, similar symbols typically identify similar components, unless context dictates otherwise. The example embodiments described herein are not meant to be limiting. Other embodiments may be utilized, and other changes may be made, without departing from the scope of the subject matter presented herein. It will be readily understood that the aspects of the present disclosure, as generally described herein and illustrated in the figures can be arranged, substituted, combined, separated, and designed in a wide variety of different configurations, all of which are contemplated herein. Example embodiments described herein are not meant to be limiting.

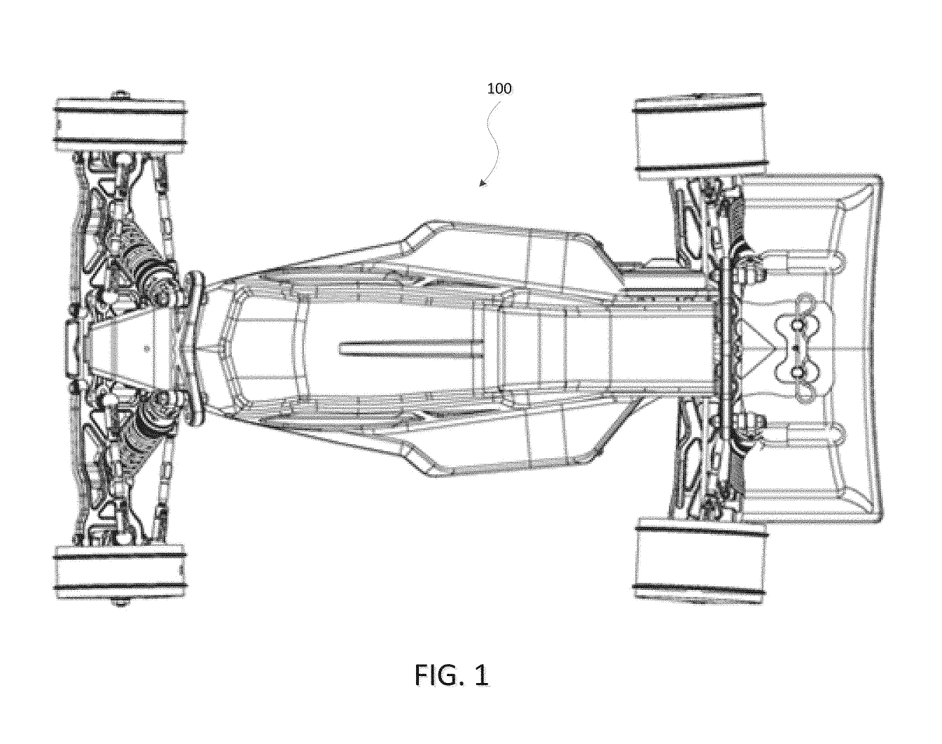

FIG. 1 illustrates a top view of an adjustable chassis of a radio-controlled (RC) vehicle 100, according to an example embodiment.

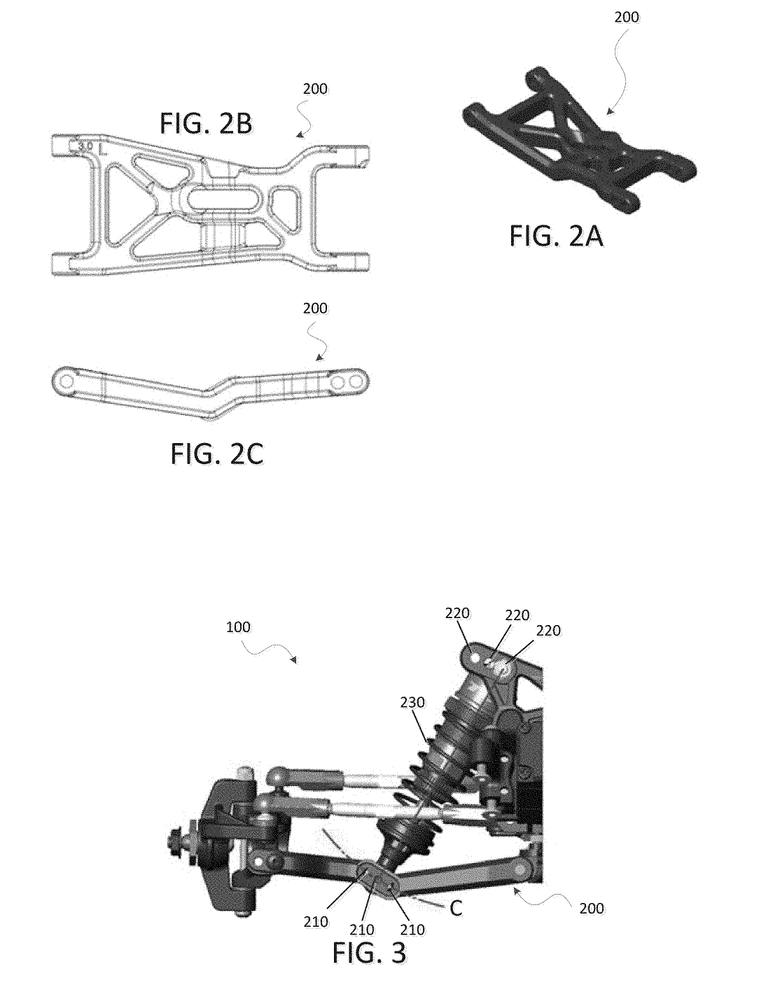

FIG. 2A is a perspective view of a suspension arm 200 of a RC vehicle, according to an example embodiment. FIG. 2B is a top view of the suspension arm of FIG. 2A. FIG. 2C is a side view of the suspension arm of FIG. 2A.

FIG. 3 is a cut-out view of a RC vehicle, further illustrating a suspension arm, according to an example embodiment. FIG. 3 illustrates a suspension arm 200 coupled to a RC vehicle chassis 100, suspension arm shock apertures 210, top shock mounting apertures 220, and a shock 230. The shock 230 mounts to the top shock mounting apertures 220 and to the suspension arm shock apertures 210 via screws, clips, other fasteners, or other removable fastening means.

When changing the shock position on a traditional front arm suspension arm, the suspension travel is affected which may require the shocks to be uninstalled and disassembled. Further, the shock position change may also require the addition or removal of spacers to adjust the shock length and reassemble the shock and reinstall it.

In contrast to a traditional suspension arm, an adjustable vehicle chassis according to some embodiments includes multiple suspension arm apertures (such as suspension arm shock apertures 210) where the position of the shock 230 can be quickly and easily changed by simply removing a screw, clip, or other fastener, moving the shock 230 over to the desired aperture, and replacing the screw, clip, or other fastener. Advantageously, the shock position is changed without the need to disassemble or rebuild the shock.

In some embodiments, the suspension arm 200 is designed to allow a change in shock position while maintaining the same suspension travel (e.g., the amount of movement that the suspension moves up and down). For example, as shown in FIG. 3, the suspension arm 200 has suspension arm shock apertures 210 that are configured along a curve C. The curve C is an arc of a circle with a radius that is equal to the length of the suspension travel.

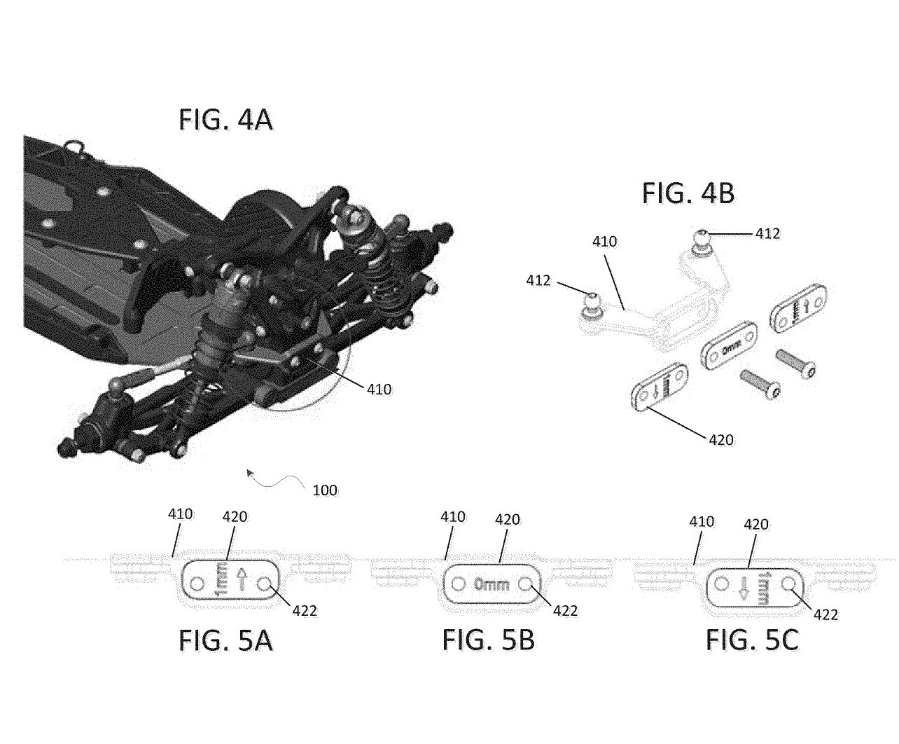

FIG. 4A is a cut-out view of a RC vehicle, further illustrating a camber block according to an example embodiment. FIG. 4B is an exploded view of the camber block of FIG. 4A. FIGS. 4A and 4B illustrate a vehicle chassis 100 with a rear camber block 410, camber inserts 420, and ball studs 412. Roll center is part of suspension geometry, and the adjustable camber block 410 shown in FIGS. 4A and 4B allows changes to the characteristics of a vehicle's roll center by using different camber inserts 420. The roll center runs between suspension pick up (e.g., the hinge pin on the bottom that goes through the suspension arm, a hinge pin on the outside that goes through the hub, and a camber link, which may be a turnbuckle with a ball cup on either end with a ball stud that mounts to the turnbuckle and that acts as the upper control arm). By changing the characteristics (e.g., the height or angle) of the camber block 410, the roll center characteristics of the RC vehicle are changed.

In some embodiments, an adjustable chassis 100 has a rear camber block 410 that can adjust ball studs 412 without having to remove them. In previous traditional RC vehicles, a user would have to remove the ball studs and add or remove washers underneath the ball studs to adjust the height of the ball studs. Camber inserts 420 mounted externally to the camber block 410 and are used, as shown further in FIGS. 5A, 5B, and 5C to adjust the roll center of the vehicle. This is advantageous because the roll center can be adjusted without having to remove the ball stud. Further, there is no need to access the top of bolts (as required in some previous systems), so there is no need to access the shock tower. As an additional benefit, this configuration makes it easier to remove the transmission and differential.

FIG. 5A illustrates an example camber insert, according to an example embodiment. In this embodiment, camber insert 420 has two apertures 422 that are coupled to the camber block 410 (e.g., via screws, clips, or other fasteners) to move the camber block 410 up one millimeter.

FIG. 5B illustrates an example camber insert, according to an example embodiment. In this embodiment, camber insert 420 has two apertures 422 that are coupled to the camber block 410 (e.g., via screws, clips, or other fasteners) to have a zero millimeter change in the height of the camber block 410.

FIG. 5C illustrates an example camber insert, according to an example embodiment. In this embodiment, camber insert 420 has two apertures 422 that are coupled to the camber block 410 (e.g., via screws, clips, or other fasteners) to move the camber block 410 down one millimeter.

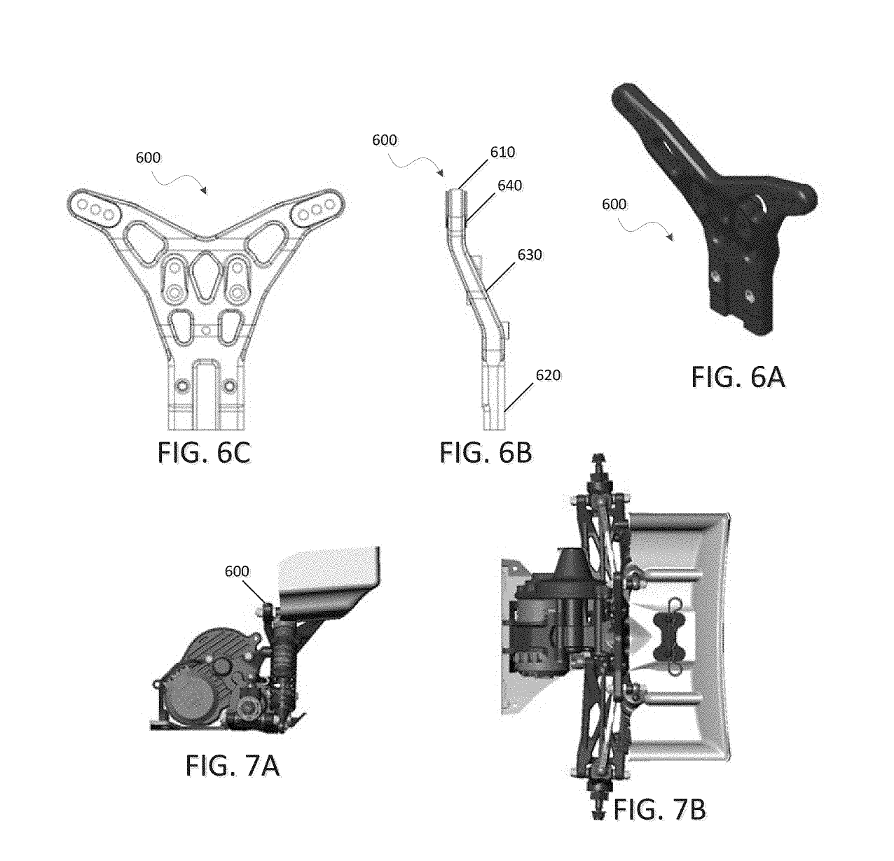

FIG. 6A is a perspective view of a shock tower 600, according to an example embodiment. FIG. 6B is a side view of the shock tower of FIG. 6A. FIG. 6B illustrates a shock tower 600 with a top 610, a first portion 620, a second portion 630, and a third portion 640. FIG. 6C is a front view of the shock tower of FIG. 6A.

Some parts of RC vehicles are specific sizes and are difficult to move. In the rear suspension, the whole rear suspension is built around the location of the differential gear. For a mid-motor vehicle application, the motor goes in front of the differential gear. Although the motor can be installed at varying distances to the differential gear, that can negatively affect the handling of the vehicle. With a mid-motor application, since the motor is in front of the differential gear, the transmission is above the differential gear and the motor and between both of them. In some embodiments, the mounting of the rear suspension, rear shock tower, and camber block is behind the differential gear. Thus, the rear shock tower is behind the rear differential gear. If the shock tower were to go straight up vertically (as in conventional vehicles), that is by default the farthest forward the wing can be mounted.

In some embodiments (like that shown in FIGS. 7A and 7B), the shock tower 600 is designed to go half way up, then veer forward, and then straighten back out. This design moves the wing and shock mounting further forward on the car (especially as compared to traditional RC vehicles), improving the vehicle aerodynamics.

FIG. 7A is a cut-out and side view of a RC vehicle, further illustrating the shock tower of FIG. 6A. FIG. 7B is a top view of FIG. 7A.

While particular aspects and embodiments are disclosed herein, other aspects and embodiments will be apparent to those skilled in the art in view of the foregoing teaching. For example, while the embodiments are described with respect to applications for RC aircraft, the disclosed systems and methods are not so limited. Further, while certain shapes, sizes, and materials are described, the disclosed systems and methods are not so limited. The various aspects and embodiments disclosed herein are for illustration purposes only and are not intended to be limiting, with the true scope and spirit being indicated by the following claims.

We claim:

1. A radio-controlled (RC) vehicle comprising:
a chassis with at least one top shock mounting aperture;
a shock coupled to the at least one top shock mounting aperture;
a suspension arm coupled to the chassis and comprising a plurality of suspension arm shock apertures, wherein the shock is coupled to at least one of the plurality of suspension arm shock apertures, and wherein the suspension arm has a suspension travel.

2. The RC vehicle of claim 1, wherein the suspension arm shock apertures are configured substantially along a curve; wherein the curve is an arc of a circle with a radius that is approximately equal to the length of the suspension travel.

3. The RC vehicle of claim 2, wherein the shock is removably coupled to the suspension arm.

4. The RC vehicle of claim 3, wherein the shock is removably coupled to the top shock mounting aperture of the chassis.

5. A radio-controlled (RC) vehicle comprising:
a chassis with at least one top shock mounting aperture;
a shock coupled to the at least one top shock mounting aperture, wherein the shock has a shock travel;
a suspension arm coupled to the chassis and comprising a plurality of suspension arm shock apertures, wherein the shock is coupled to at least one of the plurality of suspension arm shock apertures, and wherein the suspension arm has a suspension travel; and
a rear camber block coupled to the chassis and at least one ball stud; wherein the rear camber block is configured to accept a plurality of camber inserts, wherein the plurality of camber inserts comprise camber insert apertures.

6. The RC vehicle of claim 5, wherein the suspension arm shock apertures are configured substantially along a curve; wherein the curve is an arc of a circle with a radius that is approximately equal to the length of the shock travel.

7. The RC vehicle of claim 6, wherein the plurality of camber inserts comprises a first camber insert with a first camber insert aperture location; wherein the chassis has a first roll center based at least in part on the first camber insert aperture location.

8. The RC vehicle of claim 7, wherein the plurality of camber inserts comprises a second camber insert with a second camber insert aperture location; wherein the chassis has a second roll center based at least in part on the second camber insert aperture location.

9. A radio-controlled (RC) vehicle comprising:
a chassis with at least one top shock mounting aperture;
a shock coupled to the at least one top shock mounting aperture, wherein the shock has a shock travel;
a suspension arm coupled to the chassis and comprising a plurality of suspension arm shock apertures, wherein the shock is coupled to at least one of the plurality of suspension arm shock apertures, and wherein the suspension arm has a suspension travel;
a rear camber block coupled to the chassis and at least one ball stud; wherein the rear camber block is configured to accept a plurality of camber inserts, wherein the plurality of camber inserts comprise camber insert apertures, and wherein the rear camber block is coupled to an initial camber insert with an insert height and an insert angle; and
a rear shock tower coupled to the chassis, wherein the rear shock tower is coupled to the chassis at a first location along the chassis and at least part of the rear shock tower is angled such that the rear shock tower top is at a second location along the chassis.

10. The RC vehicle of claim 9, wherein the suspension arm shock apertures are configured substantially along a curve; wherein the curve is an arc of a circle with a radius that is approximately equal to the length of the shock travel.

11. The RC vehicle of claim 10, wherein the shock is removably coupled to the suspension arm.

12. The RC vehicle of claim 11, wherein the shock is removably coupled to the top shock mounting aperture of the chassis.

13. The RC vehicle of claim 10, wherein the plurality of camber inserts comprises a first camber insert with a first camber insert aperture location; wherein the chassis has a first roll center based at least in part on the first camber insert aperture location when the first camber insert is coupled to the rear camber block.

14. The RC vehicle of claim 13, wherein the plurality of camber inserts comprises a second camber insert with a second camber insert aperture location; wherein the chassis has a second roll center based at least in part on the second camber insert aperture location when the second camber insert is coupled to the rear camber block.

15. The RC vehicle of claim 9, further comprising a wing coupled to the rear shock tower top.

16. The RC vehicle of claim 9, wherein the shock is not disassembled when switching between the plurality of suspension arm shock apertures.

17. The RC vehicle of claim 10, wherein the suspension travel is not changed when the shock is switched between the plurality of suspension arm shock apertures.

18. The RC vehicle of claim 9, wherein the roll center of the chassis is altered by changing the height of the camber block; and wherein the height of the camber block is changed by removing the initial camber insert and coupling the camber block to a height camber insert.

19. The RC vehicle of claim 9, wherein the roll center of the chassis is altered by changing the angle of the camber block; and wherein the angle of the camber block is changed by removing the initial camber insert and coupling the camber block to an angle camber insert.

20. The RC vehicle of claim 9, wherein the angle and the height of the camber block are altered by removing the initial camber insert and coupling the camber block to a combination camber insert.
